(19) United States
(12) Patent Application Publication
(10) Pub. No.: US 2011/0072798 A1
(43) Pub. Date: Mar. 31, 2011

(54) NOx CONTROL REQUEST FOR NH3 STORAGE CONTROL

(76) Inventor: Andrew D. Herman, Grand Blanc, MI (US)

(21) Appl. No.: 12/568,200

(22) Filed: Sep. 28, 2009

(51) Int. Cl. F01N 9/00; F02B 47/08

(52) U.S. Cl. 60/286; 123/568.21

(57) ABSTRACT

An exhaust gas treatment system includes a selective catalytic reduction (SCR) catalyst and a dosing control responsive to exhaust gas operating conditions for controlling the dosing rate of a reductant such as aqueous urea into the exhaust stream. When the dosing control determines that NH₃ slip cannot be maintained within acceptable limits, even after disabling dosing, the dosing control generates a control message destined for the engine control unit (ECU) requesting that the ECU decrease the exhaust gas recirculation (EGR) rate. The decrease in the EGR rate is effective to increase the engine-out NOx level, which increases NOx availability in the SCR catalyst. As a result, excess NH₃ in the SCR catalyst is used for NOx conversion rather than escaping out through the tailpipe as excessive NH₃ slip.

### TECHNICAL FIELD

The present invention relates generally to an exhaust gas treatment system for use with an internal combustion engine system where the treatment system is of the type using a selective catalytic reduction (SCR) catalyst, and more specifically to systems and methods for operation of the same.

### BACKGROUND OF THE INVENTION

There have been a variety of exhaust gas treatment systems developed in the art to minimize emission of undesirable constituent components of internal combustion engine exhaust gas. For example, it is known to reduce NOx emissions using a SCR catalyst, treatment device that includes a catalyst and a system that is operable to inject material, such as ammonia (NH₃), into the exhaust gas feedstream ahead of the catalyst. The SCR catalyst is constructed so as to promote the reduction of NOx by NH₃ (or other reductant, such as aqueous urea which undergoes decomposition in the exhaust to produce NH₃). NH₃ or urea selectively combine with NOx to form N₂ and H₂O in the presence of the SCR catalyst, as described generally in U.S. Patent Publication 2007/0271908 entitled “ENGINE EXHAUST EMISSION CONTROL SYSTEM PROVIDING ON-BOARD AMMONIA GENERATION”. For diesel engines, for example, selective catalytic reduction (SCR) of NOx with ammonia is perhaps the most selective and active reaction for the removal of NOx in the presence of excess oxygen. The NH₃ source must be periodically replenished and the injection of NH₃ into the SCR catalyst requires precise control. Over-injection may cause a release of NH₃ (“slip”) out of the tailpipe into the atmosphere, while under-injection may result in inadequate emissions reduction (i.e., inadequate NOx conversion to N₂ and H₂O).

These systems have been amply demonstrated in the stationary catalytic applications. For mobile applications where it is generally not possible (or at least not desirable) to use ammonia directly, urea-water solutions have been proven to be suitable sources of ammonia in the exhaust gas stream. This has made SCR possible for a wide range of vehicle applications.

Increasingly stringent demands for low tail pipe emissions of NOx have been placed on heavy duty diesel powered vehicles. Liquid urea dosing systems with selective catalytic NOx reduction (SCR) technologies have been developed in the art that provide potentially viable solutions for meeting current and future diesel NOx emission standards around the world. Ammonia emissions may also be set by regulation or simply as a matter of quality. For example, European emission standards (e.g., EU 6) for NH₃ slip targets specify 10 ppm average and 30 ppm peak. However, the challenge described above remains, namely, that such treatment systems achieve maximum NOx reduction (i.e., at least meeting NOx emissions criteria) while at the same time maintaining acceptable NH₃ emissions, particularly over the service life of the treatment system.

However, there are situations where conventional controls are unable to regulate, albeit for relatively short periods of time, NH₃ slips to within acceptable levels, even when the dosing control disables NH₃ dosing entirely. These situations are undesirable.

There is therefore a need for systems and methods of operating a exhaust gas treatment system that minimize or eliminate one or more of the problems set forth above.

### SUMMARY OF THE INVENTION

The invention provides an advantage for exhaust gas treatment systems that use ammonia or other reductant (e.g., aqueous urea solution) injection in combination with an SCR catalyst for NOx removal from the engine exhaust gas. Embodiments consistent with the invention involve interaction between the exhaust gas treatment system and the engine system so that the needs of the exhaust gas treatment system are satisfied. For example, when the exhaust treatment system determines that it does not have the ability to control tailpipe NH₃ slip, such interaction may involve transmitting a control request to the engine system for increasing the engine-out NOx level, for the purpose of reducing NH₃ slip to within acceptable levels. Through the foregoing interaction, the goals of the exhaust treatment system can be met.

In one aspect of the invention, a method is provided for reductant slip control. The method is applicable for use in internal combustion engine systems producing an exhaust gas stream destined for an exhaust treatment system. The method involves the step of determining an operating characteristic associated with the exhaust gas treatment system. In one embodiment, this characteristic may be a reductant slip level (e.g., NH₃ slip level). The next step may involve forming a control request (e.g., in the dosing control portion of the overall exhaust treatment system) based on the determined operating characteristic. In an embodiment where the exhaust treatment characteristic is NH₃ slip, this step may involve generating a message operative to alter the operation of the engine system so as to increase the engine-out NOx level. Finally, transmitting the control request (i.e., message) to the engine system (e.g., an engine control unit (ECU)). In a preferred embodiment, the message may communicate the request to the ECU to decrease the EGR rate, which in turn results in an increase in the engine-out NOx level. The increased amount of NOx provided to the selective catalyst reduction (SCR) catalyst can react with the excess stored NH₃, resulting in a reduction in the NH₃ slip level to within acceptable limits. In one embodiment, the control request is transmitted only when the exhaust gas treatment system has run out of authority to further decrease NH₃ injection (e.g., has already disabled NH₃ dosing) but is unable to maintain control of the NH₃ slip within acceptable thresholds. It should be appreciated that other requests can be made by the dosing control directed to other aspects of engine operation, all in furtherance of and to meet the needs/goals of the treatment system.

A corresponding system is also presented.

### BRIEF DESCRIPTION OF THE DRAWINGS

The present invention will now be described by way of example, with reference to the accompanying drawings:

FIG. 1 is a diagrammatic and block diagram showing an exhaust treatment system in which the operating method of the invention may be practiced.

FIG. 2 is a block diagram showing an overview of a dosing control that includes an SCR model, suitable for use in an exhaust treatment system according to the invention.

FIG. 3 is a signal flow mechanization schematic showing inputs and outputs of the SCR model.

FIG. 4 is a simplified flowchart diagram showing a method of operating an exhaust treatment system according to the invention.

### DETAILED DESCRIPTION OF THE PREFERRED EMBODIMENT

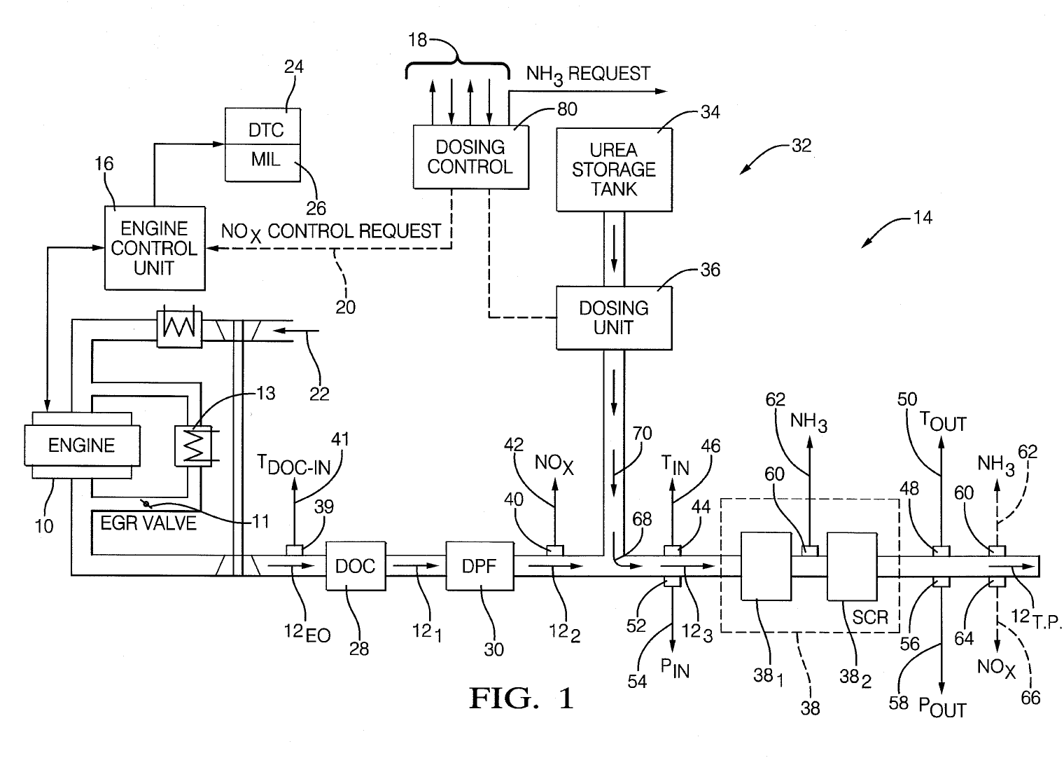

Referring now to the drawings wherein like reference numerals are used to identify identical components in the various views, FIG. 1 is a diagrammatic and block diagram showing an exemplary diesel cycle internal combustion engine system 10 whose combustion exhaust gas 12 is fed to a selective catalytic reduction (SCR) based exhaust gas treatment system 14. The exhaust gas is represented as a stream flowing through the exhaust gas treatment system 14 and is shown as a series of arrows designated 12_{EO} (engine out), 12₁, 12₂, 12₃ and 12_{TP} (tail pipe). It should be understood that while the invention will be described in connection with an automotive vehicle (i.e., mobile) embodiment, the invention may find useful application in stationary applications as well. In addition, embodiments of the invention may be used in heavy-duty applications (e.g., highway tractors, trucks and the like) as well as light-duty applications (e.g., passenger cars). Moreover, embodiments of the invention may find further useful application in various types of internal combustion engines, such as compression-ignition (e.g., diesel) engines as well as spark-ignition engines.

In the illustrative embodiment, the engine 10 may be a turbocharged diesel engine. In a constructed embodiment, the engine 10 comprised a conventional 6.6-liter, 8-cylinder turbocharged diesel engine commercially available under the DuraMax trade designation. As also shown, the engine 10 may be equipped with an exhaust gas recirculation (EGR) valve 11 and optionally an EGR cooler 13, both elements of which may comprise conventional components. As known, EGR involves recirculating a portion of the engine exhaust (engine-out) to the engine intake. The recirculated gas is generally inert and serves to dilute the intake charge, among other things. One result of EGR is a reduction in the NOx concentration level in the engine-out exhaust gas stream. It should be understood that while the illustrated approach for implementing EGR is common, particularly with contemporary diesel engines, it is exemplary and not limiting in nature. Alternate approaches may be employed. For example, it is known to provide cam phasing control, where the overlap of intake and exhaust valves is controlled to achieve the same effect. While the cam phasing approach can be implemented without separate EGR valve/plumbing, it adds other requirements, as known. Accordingly, EGR as used herein refers to redirecting and/or controlling the amount of exhaust gas redirected and/or retained in the cylinder as an inert gas, which does not combust. Since the inert gas does not combust, the higher the EGR rate, typically the lower the combustion temperature (and vice-versa), which avoids the temperature range where NOx is generated.

FIG. 1 also shows an engine control unit (ECU) 16 configured to control the operation of the engine 10. The ECU 16 may comprise conventional apparatus known generally in the art for such purpose. Generally, the ECU 16 may include at least one microprocessor or other processing unit, associated memory devices such as read only memory (ROM) and random access memory (RAM), a timing clock, input devices for monitoring input from external analog and digital devices and controlling output devices. The ECU 16 is operable to monitor engine operating conditions and other inputs (e.g., operator inputs) using the plurality of sensors and input mechanisms, and control engine operations with the plurality of output systems and actuators, using pre-established algorithms and calibrations that integrate information from monitored conditions and inputs. It should be understood that many of the conventional sensors employed in an engine system have been omitted for clarity.

The software algorithms and calibrations which are executed in the ECU 16 may generally comprise conventional strategies known to those of ordinary skill in the art. Overall, in response to the various inputs, the ECU 16 develops the necessary outputs to control the throttle valve position (for engine load control), fueling (fuel injector opening, duration and closing), spark (ignition timing—if so equipped) and other aspects, all as known in the art.

In addition to the control of the engine 10, the ECU 16 is also typically configured to perform various diagnostics. For this purpose, the ECU 16 may be configured to include a diagnostic data manager or the like, a higher level service arranged to manage the reports received from various lower level diagnostic routines/circuits, and set or reset diagnostic trouble code(s)/service codes, as well as activate or extinguish various alerts, all as known generally in the art. For example only, such a diagnostic data manager may be pre-configured such that certain non-continuous monitoring diagnostics require that such diagnostic fail twice before a diagnostic trouble code (DTC) is set and a malfunction indicator lamp (MIL) is illuminated. As shown in FIG. 1, the ECU 16 may be configured to set a corresponding diagnostic trouble code (DTC) 24 and/or generate an operator alert, such an illumination of a MIL 26. Although not shown, in one embodiment, the ECU 16 may be configured so as to allow interrogation (e.g., by a skilled technician) for retrieval of such set DTCs. Generally, the process of storing diagnostic trouble codes and subsequent interrogation and retrieval is well known to one skilled in the art and will not be described in any further detailed.

The exhaust gas treatment system 14 may be a selective catalytic reduction (SCR) catalyst based system. As shown in FIG. 1, the exemplary system 14 may include may include a diesel oxidation catalyst (DOC) 28, a diesel particulate filter (DPF) 30, a dosing subsystem 32 including at least (i) a reductant (e.g., urea-water solution) storage tank 34 and (ii) a dosing unit 36, and a selective catalytic reduction (SCR) catalyst 38. In addition, FIG. 1 shows various sensors disposed in and/or used by the treatment system 14. These may include a DOC inlet temperature sensor 39 configured to generate a DOC inlet temperature signal 41 (T_{DOC-IN}), a NOx sensor 40 configured to generate a NOx signal 42 (NOx) indicative of a sensed NOx concentration, a first exhaust gas temperature sensor 44, located at the inlet of the SCR catalyst 38, configured to generate a first temperature signal 46 (T_{IN}), an optional second exhaust gas temperature sensor 48 configured to generate a second temperature signal 50 (T_{OUT}), a first pressure sensor 52 configured to generate a first pressure signal 54 (P_{IN}), a second pressure sensor 56 configured to generate a second pressure signal 58 (P_{OUT}), and an ammonia (NH₃) concentration sensor 60 configured to generate an ammonia concentration signal 62 indicative of the sensed NH₃ concentration. In many commercial vehicles, a NOx sensor 64 is provided for generating a second NOx signal 66 indicative of the NOx concentration exiting the tail pipe. However, such is shown for completeness only.

NH₃ Slip and EGR Control. As described in the Background, the SCR-based exhaust treatment system 14 includes a precision dosing control configured to inject a measured amount of reductant (NH₃ or aqueous urea) to achieve the dual goals of reducing tailpipe NOx emissions while also maintaining reductant (NH₃) slip within acceptable concentration levels. Over-injection may cause a release of NH₃ (“slip”) out of the tailpipe into the atmosphere, while under-injection may result in inadequate emissions reduction (i.e., inadequate NOx conversion to N₂ and H₂O). However, under certain circumstances, tailpipe NH₃ concentration levels exceed desired thresholds. Within the SCR system 14, there exists predominantly two ways to deal with (reduce) NH₃ slip: (1) reduce or discontinue the introduction of ammonia into the SCR catalyst by adjusting the dosing control method; or (2) ensure sufficient NOx for conversion with the ammonia stored in the SCR catalyst. To solve the problem of uncontrolled NH₃ slip, the invention provides a mechanism to request an increase in the amount of NOx available to the SCR control system. The request may be by way of an internal data control message or by an external serial data message, in any case both directed to the engine control unit (ECU) 16 and requesting that the ECU increase engine-out NOx production.

In the illustrative diesel engine embodiment, it is known to provide aggressive EGR schedules (i.e., EGR rates), which among other things tends to minimize engine-out NOx levels (i.e., contained in engine-out exhaust gas stream 12_{E-O}) ostensibly to meet emissions compliance criteria. EGR schedules are typically determined by engine speed and engine load. “EGR rate” is the amount of exhaust gas returned to the cylinder to be mixed with intake air. There are a variety of measurements for this amount of EGR. In one embodiment, an EGR rate may be expressed as an EGR flow in grams per second, but a ratio (e.g., percentage) of cylinder volume relative to intake versus exhaust gases is also common. Accordingly, in a conventional configuration, existing diesel engine control schemes would have room for a reduction in the normal EGR rate so as to increase the engine-out NOx concentration levels. SCR chemistry demonstrates that the reduction of NH₃ available in the SCR catalyst (i.e., SCR catalyst 38—FIG. 1) can be achieved with an increase in the available NOx.

When the SCR dosing control 80 (best shown in FIG. 1) determines that the ability of the exhaust treatment system 14 to mitigate NH₃ slip cannot be achieved, the dosing control 80 is configured to generate a request, such as NOx control request message 20, which is transmitted to the ECU 16. Such NOx control message may, for example, request the ECU to reduce the EGR rate, effectively increasing the amount of available NOx to the SCR catalyst 38 (FIG. 1) for NOx conversion using the NH₃ stored in the SCR catalyst 38. This increase in engine-out NOx is configured to reduce the amount of available NH₃ that could possibly exit the exhaust gas treatment system 14 (i.e., at the tailpipe—exhaust stream 12_{TP}).

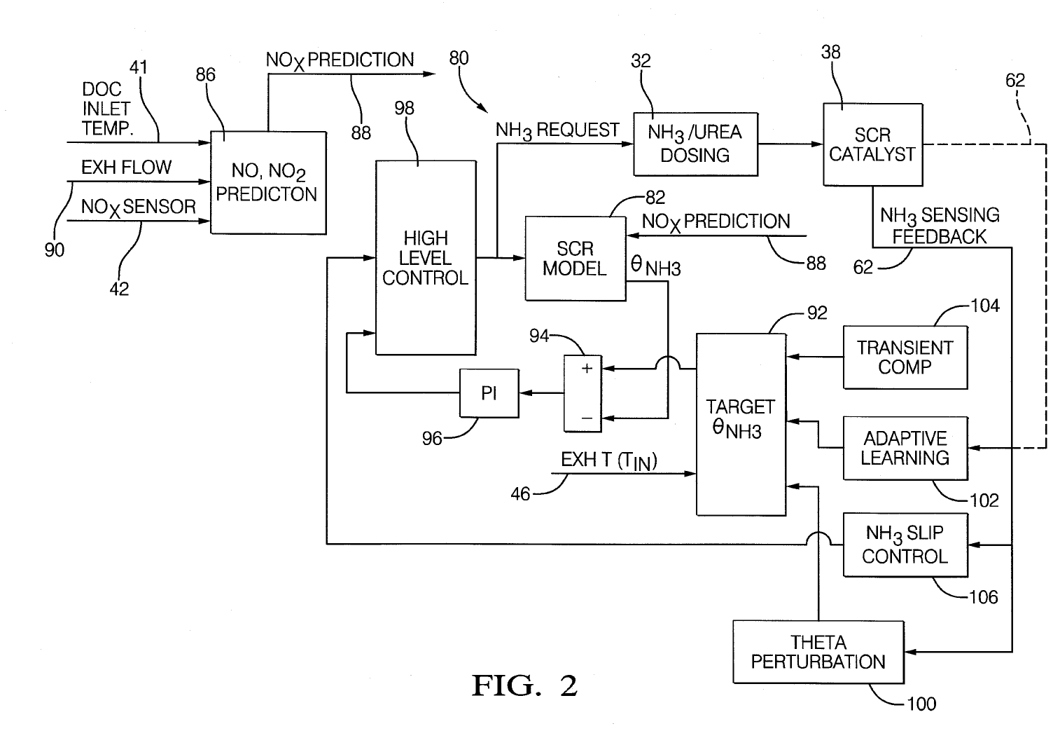

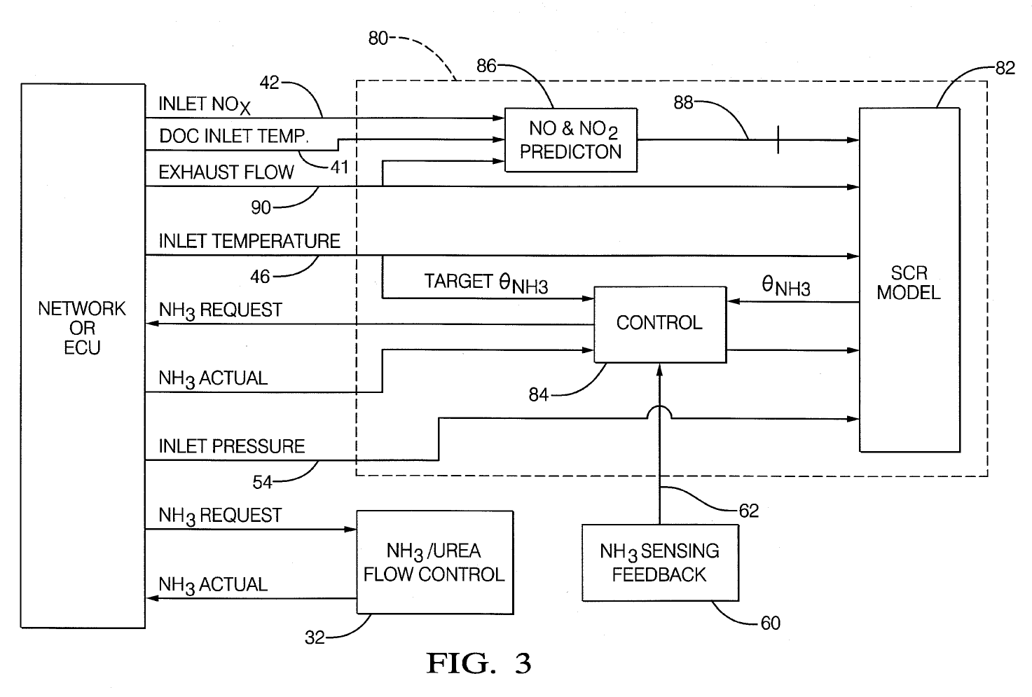

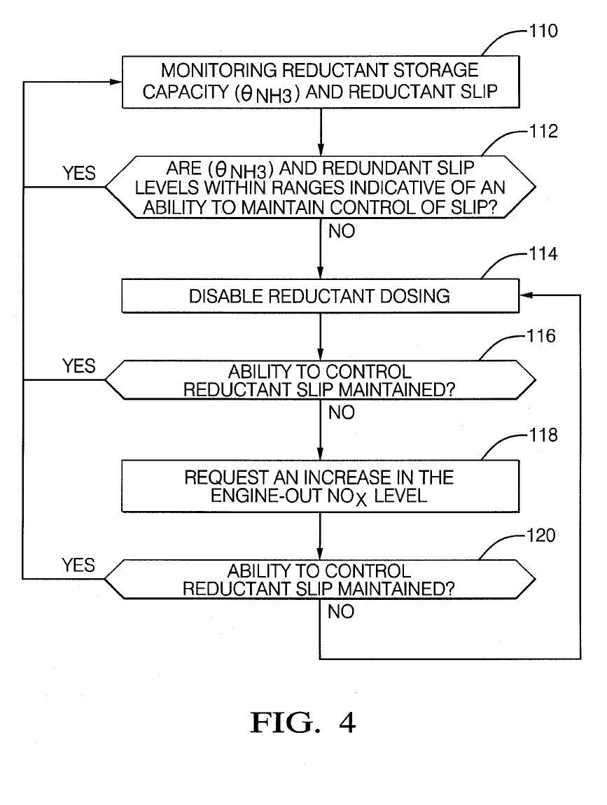

FIGS. 2-3 illustrate the exemplary exhaust gas treatment system 14 in some detail. Generally, the system 14 is configured for precision control of the injected amount of reductant (i.e., ammonia or aqueous urea) needed for conversion of NOx in the SCR catalyst 38, to thereby reduce the tailpipe NOx concentration. The dosing control 80 (FIG. 1) implements such a control strategy by producing an output in the form of an NH₃ Request signal, which is communicated to the dosing unit 36 (i.e., shown as the “NH₃/Urea Dosing”). In one embodiment, the NH₃ Request signal is indicative of the mass flow rate at which the dosing subsystem 32 is to introduce the urea-water solution into the exhaust gas stream. The control variable used in implementing the dosing control strategy is a so-called ammonia surface coverage parameter theta (θ_{NH3}), which corresponds to the NH₃ surface storage fraction associated with the SCR catalyst 38. The ammonia surface coverage parameter theta (θ_{NH3}) indicates the amount of ammonia—NH₃ stored in the SCR catalyst 38. The dosing control 80 makes uses of an SCR model 82 (shown in FIG. 2), which models the operation/behavior of the SCR catalyst 38. Before proceeding with a detailed description of the exemplary exhaust treatment system 14, however, an overview of the method of the invention will first be set forth in connection with FIG. 4.

FIG. 4 is a flowchart showing an embodiment of a method of the invention. The method includes a number of steps and begins in step 110.

In step 110, the dosing control 80 executes in accordance with a predetermined control strategy configured to optimize the injection amount (rate) of the NOx reductant being used (e.g., aqueous urea). This step involves monitoring the reductant storage capacity (i.e., the theta parameter θ_{NH3}) as well as the NH₃ concentration level being emitted from the tailpipe (i.e., the NH₃ slip). The method then proceeds to step 112.

In step 112, the dosing control 80 determines whether it can control (i.e., determine a value for) a target theta (target θ_{NH3}) such that the NH₃ slip can be maintained within acceptable limits. In this regard, the dosing control 80 may rely on, among other things, the various outputs of the SCR model 82, the characteristics of the various control blocks (e.g., see FIG. 2, PI control block 96 and high level control block 98) as well as various real-time operating data (e.g., see FIG. 2, inlet temperature, exhaust flow, etc.). If the answer in this decision step is YES, then the method branches back to step 110 (“monitoring”). However, a “NO” answer means that the dosing control 80 has determined that it is unable to maintain NH₃ slip within acceptable limits, here in the illustrated embodiment, through theta parameter (storage) control. On the other hand, if the answer in this step is NO, then the method branches to step 114.

In step 114, the dosing control 80 disables or otherwise discontinues reductant dosing entirely. This is the control's first response to excessive NH₃ slip. This step is adapted to reduce the amount of stored NH₃ in the SCR catalyst 38, with the end goal of reducing the NH₃ slip to within acceptable limits. The method then proceeds to step 116.

In step 116, the dosing control 80 again determines whether the exhaust treatment system 14 has the ability to control the NH₃ slip to within acceptable limits. In other words, has the previous step of disabling reductant (urea) dosing reduced the stored NH₃ to levels such that the dosing control 80 can now regulate the operation of the exhaust treatment system so that tailpipe NH₃ emissions are within acceptable limits? If the answer in this decision block is YES, then the method branches to step 110 (“monitoring”). Otherwise, if the answer is NO (i.e., if the previous step of disabling the reductant dosing is inadequate to allow regulation of NH₃ slip to within acceptable limits), then the method branches to step 118.

In step 118, the dosing control 80 is configured to transmit a control message to the engine control unit (ECU) 16 requesting an increase in the engine-out NOx level. More specifically, in an embodiment, the dosing control 80 may form the control message so as to request a decrease in the EGR rate (as a means of increasing the engine out NOx) by a predetermined amount that is to be used by the ECU 16. The predetermined amount of EGR rate decrease may be fixed or may alternately be based on the determined NH₃ slip concentration level. The increase in the engine-out NOx level is adapted to reduce in a corresponding fashion the NH₃ slip level due the increased availability of NOx in the SCR catalyst 38.

In general terms, the method of the invention contemplates determining an operating characteristic associated with the exhaust gas treatment system, which in the example was the NH₃ slip level. Next, forming a control request based on the determined operating characteristic. Here, the control request is configured to request a reduction in the prevailing EGR rate by a predetermined amount. Finally, transmitting the control request to the ECU where the control request is configured to alter the operation of the engine system in such a way as to adjust the determined operating characteristic. Here, the reduction of the EGR rate alters the operation of the engine, which results in an increase in engine-out NOx availability. This increased NOx availability, in turn, has the result of adjusting the tailpipe NH₃ slip (i.e., the determined operating characteristic).

While the present invention may be used to provide the capability for a wide range of exhaust gas treatment systems to interact with engine controls so as to satisfy the needs of the exhaust treatment system, one exemplary exhaust treatment system, as shown in FIGS. 1-3, will now be described in detail so as to ensure that one of ordinary skill in the art may easily practice the invention. This exemplary exhaust gas treatment system may be as set forth in co-pending application Ser. No. 12/327,958 filed 4 Dec. 2008 and entitled EXHAUST GAS TREATMENT SYSTEM AND METHODS FOR OPERATING THE SAME (docket No. DP-318318), owned by the common assignee of the present invention and hereby incorporated by reference herein in its entirety, certain excerpts being reproduced below. It bears emphasizing that the following detailed description of an exhaust gas treatment system is not intended to be limiting as to the range and variety of systems that can be used in connection with the present invention.

Referring again to FIG. 1, the DOC 28 and the DPF 30 may comprise conventional components to perform their known functions.

The dosing subsystem 32 is responsive to an NH₃ Request signal produced by a dosing control 80 and configured to deliver a NOx reducing agent at an injection node 68, which is introduced in the exhaust gas stream in accurate, controlled doses 70 (e.g., mass per unit time). The reducing agent (“reductant”) may be, in general, (1) NH₃ gas or (2) a urea-water solution containing a predetermined known concentration of urea. The dosing unit 32 is shown in block form for clarity and may comprise a number of sub-parts, including but not limited to a fluid delivery mechanism, which may include an integral pump or other source of pressurized transport of the urea-water solution from the storage tank, a fluid regulation mechanism, such as an electronically controlled injector, nozzle or the like (at node 68), and a programmed dosing control unit. The dosing subsystem 32 may take various forms known in the art and may comprise commercially available components.

The SCR catalyst 38 is configured to provide a mechanism to promote a selective reduction reaction between NOx, on the one hand, and a reductant such as ammonia gas NH₃ (or aqueous urea, which decomposes into ammonia, NH₃) on the other hand. The result of such a selective reduction is, as described above in the Background, N₂ and H₂O. In general, the chemistry involved is well documented in the literature, well understood to those of ordinary skill in the art, and thus will not be elaborated upon in any greater detail. In one embodiment, the SCR catalyst 38 may comprise copper zeolite (Cu-zeolite) material, although other materials are known. See, for example, U.S. Pat. No. 6,576,587 entitled “HIGH SURFACE AREA LEAN NOx CATALYST” issued to Labarge et al., and U.S. Pat. No. 7,240,484 entitled “EXHAUST TREATMENT SYSTEMS AND METHODS FOR USING THE SAME” issued to Li et al., both owned by the common assignee of the present invention, and both hereby incorporated by reference in their entirety. In addition, as shown, the SCR catalyst 38 may be of multi-brick construction, including a plurality of individual bricks 38₁, 38₂ wherein each “brick” may be substantially disc-shaped. The “bricks” may be housed in a suitable enclosure, as known.

The NOx concentration sensor 40 is located upstream of the injection node 68. The NOx sensor 40 is so located so as to avoid possible interference in the NOx sensing function due to the presence of NH₃ gas. The NOx sensor 40, however, may alternatively be located further upstream, between the DOC 28 and the DPF 30, or upstream of the DOC 28. In addition, the exhaust temperature is often referred to herein, and for such purpose, the temperature reading from the SCR inlet temperature sensor 44 (T_{IN}) may be used.

The NH₃ sensor 60 may be located at a mid-brick position, as shown in solid line (i.e., located anywhere downstream of the inlet of the SCR catalyst 38 and upstream of the outlet of the SCR catalyst 38). As illustrated, the NH₃ sensor 60 may be located at approximately the center position. The sensed ammonia concentration level in this arrangement, even during nominal operation, is at a small yet detectable level of mid-brick NH₃ slip, where the downstream NOx conversion with this detectable NH₃ can be assumed in the presence of the rear brick, even further reducing NH₃ concentration levels at the tail pipe to within acceptable levels. Alternatively, in certain embodiments, the NH₃ sensor 60 may be located at the outlet of the SCR catalyst 38. The remainder of the sensors shown in FIG. 1 may comprise conventional components and be configured to perform in a conventional manner known to those of ordinary skill in the art.

The dosing control 80 is configured to generate the NH₃ Request signal that is sent to the dosing unit 36, which represents the command for a specified amount (e.g., mass rate) of reductant to be delivered to the exhaust gas stream. The dosing control 80 includes a plurality of inputs and outputs, designated 18, for interface with various sensors, other control units, etc., as described herein. Although the dosing control 80 is shown as a separate block, it should be understood that depending on the particular arrangement, the functionality of the dosing control 80 may be implemented in a separate controller, incorporated into the ECU 16, or incorporated, in whole or in part, in other control units already existing in the system (e.g., the dosing unit). Further, the dosing control 80 may be configured to perform not only control functions described herein but perform the various diagnostics also described herein as well. For such purpose, the dosing control 80 may include conventional processing apparatus known in the art, capable of executing pre-programmed instructions stored in an associated memory, all performing in accordance with the functionality described herein. That is, it is contemplated that the control processes described herein will be programmed in a preferred embodiment, with the resulting software code being stored in the associated memory. Implementation of the invention, in software, in view of the foregoing enabling description, would require no more than routine application of programming skills by one of ordinary skill in the art. Such a control may further be of the type having both ROM, RAM, a combination of non-volatile and volatile (modifiable) memory so that the software can be stored and yet allow storage and processing of dynamically produced data and/or signals.

FIG. 2 is a block diagram showing an overview of the dosing control 80 of FIG. 1. The basic strategy is to control the dosing rate (e.g., urea-water solution) so as to ensure that the there is adequate ammonia stored in the SCR catalyst 38 to achieve (i) a high NOx conversion rate (i.e., conversion of NOx into N₂ and H₂O), with (ii) a low occurrence or no occurrence at all of ammonia (NH₃) slips exceeding predetermined maximum thresholds.

FIG. 3 is a signal flow mechanization schematic showing inputs and outputs of the SCR model 82. The SCR model 82 is a chemistry-based SCR model and is shown with a theta control block 84, and a “NO and NO₂” predictor block 86. The SCR model 82 is configured to model the physical SCR catalyst 38 and compute real time values for the ammonia surface coverage parameter theta (θ_{NH3}). The theta control block 84 is configured to compare the computed theta (θ_{NH3}) against a target value for theta (“Target θ_{NH3}”), which results in a theta error. The theta control block 84 is configured to use a control strategy (e.g., a proportional-integral (PI) control algorithm) to adjust the requested NH₃ dosing rate (“NH₃ Request”) to reduce the theta error. The theta control block 84 also employs closed-loop feedback, being responsive to ammonia sensing feedback by way of the ammonia sensor 60. The theta control block 84 may use NH₃ feedback generally to adapt target theta values to account for catalyst degradation, urea injection malfunction or dosing fluid concentration variation that may be encountered during real-world use. As will be described, the NH₃ sensing feedback is also used for various control and diagnostic improvements. The predictor block 86 receives the DOC inlet temperature signal 41 (T_{DOC-IN}), the NOx sensor signal 42 and the exhaust flow signal 90 as inputs and is configured to produce data 88 indicative of the respective NO and NO₂ concentration levels (engine out) produced by the engine 10. The predictor block 86 may comprise a look-up table (LUT) containing NO and NO₂ data experimentally measured from the engine 10.

The SCR model 82 may be configured to have access to a plurality of signals/parameters as needed to execute the predetermined calculations needed to model the catalyst 38. In the illustrative embodiment, this access to sensor outputs and other data sources may be implemented over a vehicle network (not shown), but which may be a controller area network (CAN) for certain vehicle embodiments. Alternatively, access to certain information may be direct to the extent that the dosing control 80 is integrated with the engine control function in the ECU 16. It should be understood that other variations are possible.

The SCR model 82 may comprise conventional models known in the art for modeling an SCR catalyst. In one embodiment, the SCR model 82 is responsive to a number of inputs, including: (i) predicted NO and NO₂ levels 88; (ii) an inlet NOx amount, which may be derived from the NOx indicative signal 42 (best shown in FIG. 1); (iii) an exhaust mass air flow (MAF) amount 90, which may be either a measured value or a value computed by the ECU 16; (iv) an SCR inlet temperature, which may be derived from the first temperature signal 46 (T_{IN}); (v) an SCR inlet pressure, which may be derived from the first pressure signal 54 (P_{IN}); and (vi) the actual amount of reductant (e.g., NH₃, urea-water solution shown as “NH₃ Actual” in FIG. 2) introduced by the dosing subsystem 32. The actual NH₃ amount helps ensure that the model provides accurate tracking of the reductant dosing. In one embodiment, values for theta (θ_{NH3}) are updated at a frequency of 10 Hz, although it should be understood this rate is exemplary only. There are a plurality of modeling approaches known in the art for developing values for a surface coverage parameter theta (θ_{NH3}), for example as seen by reference to the article by M. Shost et. al, “Monitoring, Feedback and Control of Urea SCR Dosing Systems for NOx Reduction: Utilizing an Embedded Model and Ammonia Sensing”, SAE Technical Paper Series 2008-01-1325.

Referring again to FIG. 2, the dosing control 80 may include additional blocks in certain embodiments. In particular, a target theta parameter (Target θ_{NH3}) block 92 is shown, which is configured to provide a value for the target theta parameter (Target θ_{NH3}) preferably as function of temperature (e.g., exhaust gas temperature, such as the SCR inlet temperature T_{IN}). The target θ_{NH3}, which is determined as a function of the SCR catalyst inlet temperature T_{IN}, is conventionally set-up based on the following considerations: (1) desire to achieve a maximum possible NOx conversion efficiency with acceptable NH₃ slip levels (30 ppm peak, 10 ppm average) for a given emission test cycle, and (2) recognition that limits must be set for the theta values at low temperatures to prevent potential high NH₃ slips upon sudden temperature ramp up in off-cycle tests. In other words, in a pure ammonia storage control mode (i.e., theta parameter control), different emission cycles may call for different theta values in order to achieve the best NOx conversion within the confines of the applicable NH₃ slip limits.

As shown in FIG. 2, the theta control 84 further includes a comparator 94 (e.g., a summer, or equivalent) configured to generate the theta error signal described above, indicative of the difference between the target theta (Target θ_{NH3}) and the computed theta (θ_{NH3}) from the SCR model. A PI control 96 is configured to produce an output signal configured to reduce the magnitude of the theta error. A high level control block 98 is responsive to various inputs to produce the NH₃ Request signal, which is communicated to the dosing subsystem 32.

FIG. 2 also shows, in block form, a number of additional control and diagnostic features which may optionally be included in various embodiments. These additional control and diagnostic features may be arranged to work together in some embodiments to achieve maximum NOx conversion while maintaining acceptable NH₃ slip levels under various driving conditions (i.e., in vehicle applications). The dosing control 80 thus includes a number of functional blocks to implement these features: a theta perturbation diagnostic block 100, an adaptive learning diagnostic block 102, a transient compensation control block 104 and an NH₃ slip control block 106.

The theta perturbation diagnostic block 100 is configured to perturb the target theta parameter in accordance with a small diagnostic function and to measure the resulting response to determine the state of health of one or more components of the exhaust treatment system 14. The adaptive learning diagnostic block 102 includes a diagnostic feature that monitors how much adaptation has been applied in adjusting the target theta parameter and generates an error when the level of adaptation exceeds predetermined upper and lower limits. The logic in operation is that at some level, the ability to adapt target theta values to overcome errors (e.g., reagent misdosing, reagent quality problems, SCR catalyst degradation) will reach its control limit for maintaining emissions. When this control limit is exceeded, the diagnostic generates an error. These features are described in greater detail in the co-pending patent application Ser. No. 12/327,945 entitled “DIAGNOSTIC METHODS FOR SELECTIVE CATALYTIC REDUCTION(SCR) EXHAUST TREATMENT SYSTEM”, (Attorney Docket No. DP-318283), filed 4 Dec. 2008, owned by the common assignee of the present invention, the disclosure of which is hereby incorporated by reference in its entirety.

The transient compensation block 104 involves implementing dosing reductions upon detection of certain exhaust transient conditions (“Transient Compensation”). One transient condition includes a sudden increase in the exhaust gas mass air flow, which portends a like increase in the exhaust gas temperature, which allows extra time for the dosing control to adjust NH₃ dosing before possible NH₃ slips can occur. Another transient condition includes an increasing exhaust temperature gradient. The NH₃ slip control block 106 involves shutting-off dosing altogether when certain exhaust conditions are recognized by the dosing control (“NH₃ slip control”). These features are described in greater detail in the co-pending patent application entitled EXHAUST GAS TREATMENT SYSTEM AND METHODS FOR OPERATING THE SAME (docket No. DP-318318) referred to above.

While particular embodiments of the invention have been shown and described, numerous variations and alternate embodiments will occur to those skilled in the art. Accordingly, it is intended that the invention be limited only in terms of the appended claims.

1. In an internal combustion engine system producing an exhaust gas stream to an exhaust treatment system, a method of operating the exhaust gas treatment system, comprising the steps of:
determining an operating characteristic associated with the exhaust gas treatment system;
forming a control request in a control portion of the exhaust gas treatment system, based on the determined operating characteristic; and
transmitting the control request to a control portion of the engine system wherein the control request is configured to alter an exhaust gas recirculation (EGR) strategy of the engine system in such a way as to adjust the determined operating characteristic.

2. The method of claim 1 wherein the step of determining an operating characteristic includes the sub-step of determining a reductant slip level, the step of forming a control request includes the sub-step of generating a control message operative to result alter the EGR strategy of the engine system so as to increase an engine-out NOx concentration level, and the step of transmitting the control request includes the sub-step of sending the control message to an engine control unit (ECU) portion of the engine system.

3. The method of claim 2 wherein the control message includes a request to reduce an exhaust gas recirculation (EGR) rate by a predetermined amount.

4. In an internal combustion engine system producing an exhaust gas stream comprising at least NOₓ components destined for an exhaust treatment system having a selective catalytic reduction (SCR) catalyst, a method of reductant slip control, comprising the step of:
increasing a concentration level of the NOₓ components produced by the engine system so as to reduce a reductant concentration level emitted from the SCR catalyst.

5. The method of claim 1 wherein said controlling step includes the sub-step of:
controlling an exhaust gas recirculation (EGR) portion of the engine system in accordance with a determined reductant concentration level.

6. The method of claim 5 wherein said controlling step further includes the sub-step of:
reducing an EGR rate by a predetermined amount.

7. The method of claim 4 wherein said exhaust treatment system is configured to control dosing reductant into the exhaust gas stream in an amount based on at least a reductant surface coverage parameter theta (θ) of the SCR, said method further including the steps of:
discontinuing the dosing when a reductant slip condition is detected; and
performing said step of increasing the NOₓ level when the reductant slip condition has not been abated after discontinuing said reductant dosing.

8. The method of claim 4 further including the steps of:
transmitting a message from the exhaust treatment system to the engine system requesting said increase in the engine-produced NOx concentration level.

9. The method of claim 4 wherein said reductant is selected from the group comprising ammonia (NH₃) and urea, said reductant concentration level being an ammonia concentration level, said dosing step including the sub-step of mixing the reductant with the exhaust gas upstream of the SCR catalyst.
